(19) United States
(12) Patent Application Publication
(10) Pub. No.: US 2025/0384631 A1
(43) Pub. Date: Dec. 18, 2025

(54) TRAINING METHOD, APPARATUS AND SYSTEM FOR FEATURE EXTRACTION NETWORK OF THREE-DIMENSIONAL MESH MODEL

(71) Applicant: JINGDONG TECHNOLOGY INFORMATION TECHNOLOGY CO., LTD., Beijing (CN)

(72) Inventors: Shanshan ZHAO, Beijing (CN); Yaqian LIANG, Beijing (CN); Fazhi He, Beijing (CN)

(21) Appl. No.: 18/878,433

(22) PCT Filed: Mar. 16, 2023
(86) PCT No.: PCT/CN2023/081840

§ 371 Date: Dec. 23, 2024

(30) Foreign Application Priority Data
Jun. 27, 2022 (CN) 202210736829.2

(51) Int. Cl. G06T 17/20; G06T 7/10

(52) U.S. Cl. CPC G06T 17/205; G06T 7/10; G06T 2207/20081; G06T 2207/20084

(57) ABSTRACT

A training method, apparatus and system for a feature extraction network of a 3D mesh model are provided. The method includes dividing a training 3D mesh model into a plurality of patches which do not overlap with each other, dividing the plurality of patches into first-type patches and second-type patches, and using mask embedding as a feature encoding of each second-type patch; inputting geometric representation information and positional representation information of each first-type patch into a feature extraction network; determining predicted geometric representation information of each face based on a feature encoding of each first-type patch output from the feature extraction network, the mask embedding, and positional representation information of each second-type patch, and adjusting parameters of the feature extraction network based on differences between the predicted geometric representation information and geometric representation information of the each face.

### CROSS-REFERENCE TO RELATED APPLICATIONS

The present disclosure is a U.S. National Stage Application under 35 U.S.C. § 371 of International Patent Application No. PCT/CN2023/081840, filed on Mar. 16, 2023, which is based on and claims priority of Chinese application for invention No. 202210736829.2, filed on Jun. 27, 2022, the disclosures of both of which are hereby incorporated into this disclosure by reference in its entirety.

### TECHNICAL FIELD

This disclosure relates to the field of computer vision, particularly to a training method, apparatus, and system for a feature extraction network of a three-dimensional mesh model.

### BACKGROUND

3D Mesh Model is an efficient 3D object representation widely used in various fields such as computer vision, animation, and manufacturing, etc. The use of deep learning network technology to process 3D mesh models has always been a hot topic of research in related fields.

A deep learning network is used as a feature extraction network to extract features from a 3D mesh model. The extracted features can be used for various downstream tasks, such as classifying or segmenting the 3D mesh model based on the extracted features. In related technologies, the training methods of feature extraction networks are supervised, with cross entropy as the loss function.

### SUMMARY

According to some embodiments of the present disclosure, there is provided a training method for a feature extraction network of a 3D mesh model, comprising: dividing a training 3D mesh model into a plurality of patches which do not overlap with each other, wherein each of the plurality of patches comprises a plurality of faces; dividing the plurality of patches into first-type patches and second-type patches, and using mask embedding as a feature encoding of each of the second-type patches; inputting geometric representation information and positional representation information of the each of the first-type patches into a feature extraction network; determining predicted geometric representation information of each face of the 3D mesh model based on a feature encoding of the each of the first-type patches output from the feature extraction network, the mask embedding, and positional representation information of the each of the second-type patches; and adjusting parameters of the feature extraction network based on differences between the predicted geometric representation information and geometric representation information of the each face.

In some embodiments, dividing the training 3D mesh model into a plurality of patches which do not overlap with each other comprises: simplifying the 3D mesh model into a base mesh model having a first preset number of base faces; and dividing each of the base faces in the base mesh model into a second preset number of faces, and taking the second preset number of faces divided from the each of the base faces as a patch.

In some embodiments, the method further comprises: determining predicted coordinate information of each vertex based on the feature encoding of the each of the first-type patches output from the feature extraction network, the mask embedding, and the positional representation information of the each of the second-type patches, wherein the adjusting parameters of the feature extraction network based on differences between the predicted geometric representation information and geometric representation information of each face comprises: adjusting the parameters of the feature extraction network based on the differences between the predicted geometric representation information and the geometric representation information of each face, as well as differences between the predicted coordinate information and actual coordinate information of the each vertex.

In some embodiments, the adjusting the parameters of the feature extraction network based on the differences between the predicted geometric representation information and the geometric representation information of each face, as well as differences between the predicted coordinate information and actual coordinate information of the each vertex comprises: determining a first sub-loss function based on the differences between the predicted geometric representation information and the geometric representation information of the each face; determining a second sub-loss function based on the differences between the predicted coordinate information and actual coordinate information of the each vertex; weighing and summing the first sub-loss function and the second sub-loss function to obtain a loss function; and adjusting the parameters of the feature extraction network based on the loss function.

In some embodiments, the determining a first sub-loss function based on the differences between the predicted geometric representation information and the geometric representation information of the each face comprises: determining a mean square error loss function based on the differences between the predicted geometric representation information and the geometric representation information of the each face as the first sub-loss function.

In some embodiments, the determining a second sub-loss function based on the differences between the predicted coordinate information and actual coordinate information of the each vertex comprises: determining a chamfer distance between the predicted coordinate information and the actual coordinate information of the each vertex; and determining the second sub-loss function based on the chamfer distance between the predicted coordinate information and the actual coordinate information of the each vertex.

In some embodiments, inputting geometric representation information and positional representation information of the each of the first-type patches into a feature extraction network comprises: concatenating the geometric representation information and the positional representation information of the each of the first-type patches to obtain representation information of the each of the first-type patches; inputting the representation information of the each of the first-type patches into the feature extraction network; and determining a correlation between every two first-type patches based on a self-attention mechanism in the feature extraction network; and encoding the each of the first-type patches based on the correlation between every two first-type patches to obtain a feature encoding of the each of the first-type patches.

In some embodiments, the determining predicted geometric representation information of each face of the 3D mesh model based on a feature encoding of the each of the first-type patches output from the feature extraction network, the mask embedding, and positional representation information of the each of the second-type patches comprises: concatenating the feature encoding and the positional representation information of the each of the first-type patches to obtain a code of the each of the first-type patches; concatenating the mask information and the positional representation information of each of the second-type patches to obtain a code of the each of the second-type patches; inputting the code of each of the first-type patches and the second-type patches into a decoder to obtain decoded information; and inputting the decoded information into a first linear layer to obtain the predicted geometric representation information of the each face.

In some embodiments, the determining predicted coordinate information of each vertex based on the feature encoding of the each of the first-type patches output from the feature extraction network, the mask embedding, and the positional representation information of the each of the second-type patches comprises: concatenating the feature encoding and the positional representation information of the each of the first-type patches to obtain a code of the each of the first-type patches; concatenating the mask information and the positional representation information of the each of the second-type patches to obtain a code of the each of the second-type patches; inputting the code of each of the first-type patches and the second-type patches into a decoder to obtain decoded information; and inputting the decoded information into a second linear layer to obtain the predicted coordinate information of the each vertex.

In some embodiments, the dividing a training 3D mesh model into a plurality of patches which do not overlap with each other comprises: randomly selecting some patches from the plurality of patches according to a preset ratio as the second-type patches, and taking those not selected as the first-type patches.

In some embodiments, the geometric representation information of the each face comprises at least one of three interior angle degrees, an area, a normal vector, or an inner product of three vertex vectors of the each face.

In some embodiments, the positional representation information of each patch of the first-type patches and the second-type patches is determined by: determining coordinates of a center point of the each patch; determining a position encoding for the each patch based on the coordinates of the center point of each patch.

In some embodiments, the geometric representation information of the each of the first-type patches is obtained by concatenating the geometric representation information of faces in the each of the first-type patches in a preset order.

According to other embodiments of the present disclosure, there is provided a processing method for a 3D mesh model, comprising: dividing a 3D mesh model to be processed into a plurality of patches which do not overlap with each other, wherein each of the plurality of patches comprises a plurality of faces; inputting geometric representation information and positional representation information of each of the plurality of patches into a feature extraction network; and obtaining a feature encoding of the 3D network model to be processed output from the feature extraction network.

In some embodiments, the method further comprises at least one of: segmenting the 3D mesh model to be processed based on the feature encodings of the 3D network model to be processed; or determining a category of the 3D mesh model to be processed based on the feature encodings of the 3D network model to be processed.

In some embodiments, the dividing a 3D mesh model to be processed into a plurality of patches which do not overlap with each other comprises: simplifying the 3D mesh model to be processed into a base mesh model to be processed having a third preset number of base faces; and dividing each of the base faces in the base mesh model to be processed into a fourth preset number of faces, and taking the fourth preset number of faces divided from the each of the base faces as a patch.

In some embodiments, the geometric representation information of the each face comprises at least one of three interior angle degrees, an area, a normal vector, or an inner product of three vertex vectors of the each face.

In some embodiments, the positional representation of each patch is determined by: determining coordinates of a center point of each patch; and determining a position encoding for each patch based on the coordinates of its center point.

According to some embodiments of the present disclosure, there is provided a training apparatus for a feature extraction network of a 3D mesh model, comprising: a division unit configured to divide a training 3D mesh model into a plurality of patches which do not overlap with each other, wherein each of the plurality of patches comprises a plurality of faces; an occlusion unit configured to divide the plurality of patches into first-type patches and second-type patches, and using mask embedding as a feature encoding of each of the second-type patches; an input unit configured to input geometric representation information and positional representation information of the each of the first-type patches into a feature extraction network; a prediction unit configured to determine predicted geometric representation information of each face of the 3D mesh model based on a feature encoding of the each of the first-type patches output from the feature extraction network, the mask embedding, and positional representation information of the each of the second-type patches; and an adjustment unit configured to adjust parameters of the feature extraction network based on differences between the predicted geometric representation information and geometric representation information of the each face.

According to further embodiments of the present disclosure, there is provided a processing apparatus for a 3D mesh model, comprising: a division unit configured to divide a 3D mesh model to be processed into a plurality of patches which do not overlap with each other, wherein each of the plurality of patches comprises a plurality of faces; and an input unit configured to input geometric representation information and positional representation information of each of the plurality of patches into a feature extraction network; and an acquisition unit configured to obtain a feature encoding of the 3D network model to be processed output from the feature extraction network.

According to further embodiments of the present disclosure, there is provided an electronic device, comprising: a processor; and a memory coupled to the processor for storing instructions that, when executed by the processor, cause the processor to execute the training method for a feature extraction network of a 3D mesh model according to any one of the foregoing embodiments or the processing method for a 3D mesh model according to any one of the foregoing embodiments.

According to still other embodiments of the present disclosure, there is provided a non-transitory computer-readable storage medium on which a computer program is stored, wherein the program is executed by a processor to implement the training method for a feature extraction network of a 3D mesh model according to any one of the foregoing embodiments or the processing method for a 3D mesh model according to any one of the foregoing embodiments.

According to further embodiments of the present disclosure, there is provided a training system for a feature extraction network of a 3D mesh model, comprising: the training apparatus for a feature extraction network of a 3D mesh model according to any one of the foregoing embodiments, and the processing apparatus for a 3D mesh model according to any one of the foregoing embodiments.

According to further embodiments of the present disclosure, there is provided a computer program, comprising: instructions that, when executed by a processor, cause the processor to execute the training method for a feature extraction network of a 3D mesh model according to any one of the foregoing embodiments or the processing method for a 3D mesh model according to any one of the foregoing embodiments.

Other features and advantages of the present invention will become apparent from the following detailed description of exemplary embodiments of the present disclosure with reference to the accompanying drawings.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that, the drawings illustrated as follows are merely some embodiments of the present disclosure. For a person skilled in the art, he or she may also acquire other drawings according to such drawings on the premise that no inventive effort is involved.

FIG. 1 shows a flowchart of a training method for a feature extraction network of a 3D mesh model according to some embodiments of the present disclosure;

FIG. 2 shows a schematic structure diagram of patches according to some embodiments of the present disclosure;

FIG. 3 shows a schematic diagram of the overall network architecture according to some embodiments of the present disclosure;

FIG. 4 is a schematic flowchart of a processing method for a 3D mesh model according to some embodiments of the present disclosure;

FIG. 5 shows a schematic structure diagram of a training apparatus for a feature extraction network of a 3D mesh model according to some embodiments of the present disclosure;

FIG. 6 is a schematic structure diagram of a processing apparatus for a 3D mesh model according to some embodiments of the present disclosure.

FIG. 7 shows a schematic structure diagram of an electronic device according to some embodiments of the present disclosure;

FIG. 8 shows a schematic structure diagram of an electronic device according to other embodiments of the present disclosure;

FIG. 9 shows a schematic structure diagram of a training system for a feature extraction network of a 3D mesh model according to some embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by those of ordinary skill in the art based on the embodiments of the present disclosure without creative efforts shall fall within the protection scope of the present disclosure.

The inventor has found that compared to image datasets with abundant data, the existing 3D grid model datasets have insufficient amounts of samples, and feature extraction networks trained with insufficient samples have poor accuracy. However, manually annotating a large number of 3D mesh models prior to training is inefficient and expensive.

A technical problem to be solved by the present disclosure is: how to improve the accuracy and efficiency of training a feature extraction network for a 3D mesh model, and how to improve the accuracy and efficiency of computation when there is a shortage of annotated samples of 3D mesh models.

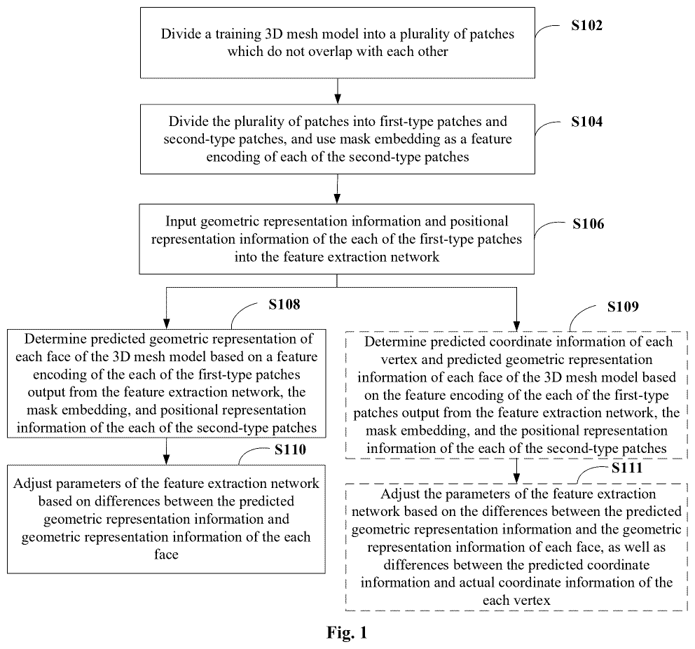

This disclosure proposes a training method for a feature extraction network of a 3D mesh model, which will be described below with reference to FIGS. 1-4.

FIG. 1 is a flowchart of a training method for a feature extraction network of a 3D mesh model according to some embodiments of the present disclosure. As shown in FIG. 1, the method of this embodiment comprises: steps S102 to S110.

In step S102, a training 3D mesh model is divided into a plurality of patches which do not overlap with each other.

A 3D mesh model consists of vertices and faces, and a structure of the faces determines connection relationships between the vertices. In a manifold 3D mesh model, each face has three adjacent faces, each edge belongs to two faces and have four adjacent edges. In order to improve the training efficiency of the feature extraction network, the 3D mesh model is divided into a plurality of patches which do not overlap with each other, and each of the patches comprises a plurality of faces. It is also possible not to divide the 3D mesh model, that is, to treat each of the faces as a patch.

For example, each of the patches contains a same number of faces. Due to the difficulty in directly dividing irregular and disordered 3D mesh models, a method is proposed to remesh a 3D mesh model. In some embodiments, the 3D mesh model is simplified into a base mesh model having a first preset number of base faces; and each of the base faces in the base mesh model is divided into a second preset number of faces, and the second preset number of faces divided from the each of the base faces are taken as a patch.

A Remesh algorithm can be used to simplify the 3D mesh model into the base mesh model with the first preset number of base faces. The first preset number can be set in a range of values, for example, a range of 96-256. Each training 3D mesh model can correspond to a different first preset number. Furthermore, each of the base faces of the base mesh model is subdivided into the second preset number of faces. All training 3D mesh models can correspond to the same second preset number. For example, the Remesh algorithm can be used to subdivide each of the base faces three times, so that each of the base faces in the base mesh model is subdivided into 64 faces. The subdivided base mesh model has a shape similar to the original 3D mesh model. In the above method, the original irregular 3D mesh model is transformed into a multi-level regular structure. Based on this structure, a plurality of faces from a same base face in the base mesh model can be grouped into a patch. It is more efficient to represent the plurality of patches obtained in this way, so that the training efficiency and stability of the feature extraction network can be improved.

In step S104, the plurality of patches are divided into first-type patches and second-type patches, and mask embedding is used as a feature encoding of each of the second-type patches.

In some embodiments, some patches are randomly selected from the plurality of patches according to a preset ratio as the second-type patches, and those that are not selected are taken as the first-type patches. For example, the (preset) mask embedding is a random vector with a same dimension as a feature encoding of each of the first-type patches output from the feature extraction network later.

In step 106, geometric representation information and positional representation information of the each of the first-type patches are input into the feature extraction network.

In some embodiments, the geometric representation information of each patch (each of the first-type patches and/or each of the second-type patches) comprises geometric representation information of each of the faces in the each patch. The geometric representation information of each face comprises shape representation information of the each face. For example, the shape representation information of the each face comprises at least one of three interior angle degrees, an area, a normal vector, or an inner product of three vertex vectors of the each face. In addition to the three interior angle degrees, the area, the normal vector, and the inner product of three vertex vectors, the shape representation information and the positional representation information of the each face can also comprise other information, which is not limited to the examples given herein. The geometric structure of the each face can be represented more accurately using the shape representation information and the position representation information, thereby improving the accuracy of the feature extraction network after training.

For example, for the each face, one or more of its three interior angle degrees, area, normal vector, and inner product of three vertex vectors can be concatenated and used as information of the each face. Embedded coding of the information of the each face is used as the geometric representation information of the each face. Embedded coding of each type of information serves as the geometric representation information of the each type of information. For example, each face has 10 dimensions of information, comprising three interior angle degrees (3 dimensions), a normal vector (3 dimensions), an inner product of three vertex vectors (3 dimensions), and an area (1 dimension).

In some embodiments, the information of all faces of each patch is arranged in a preset order and concatenated as the information of the each patch. The information of the each patch is mapped to obtain embedded coding of the each patch, which serves as the geometric representation information of the each patch. The geometric representation information of the each patch comprises the geometric representation information of each face in the each patch. For example, a first multilayer perceptron (MLP) can be used to map the information of the each patch to obtain the embedded coding {eᵢ}ᵢ₌₁^{g} for the each patch, where i is a positive integer and g is the number of patches.

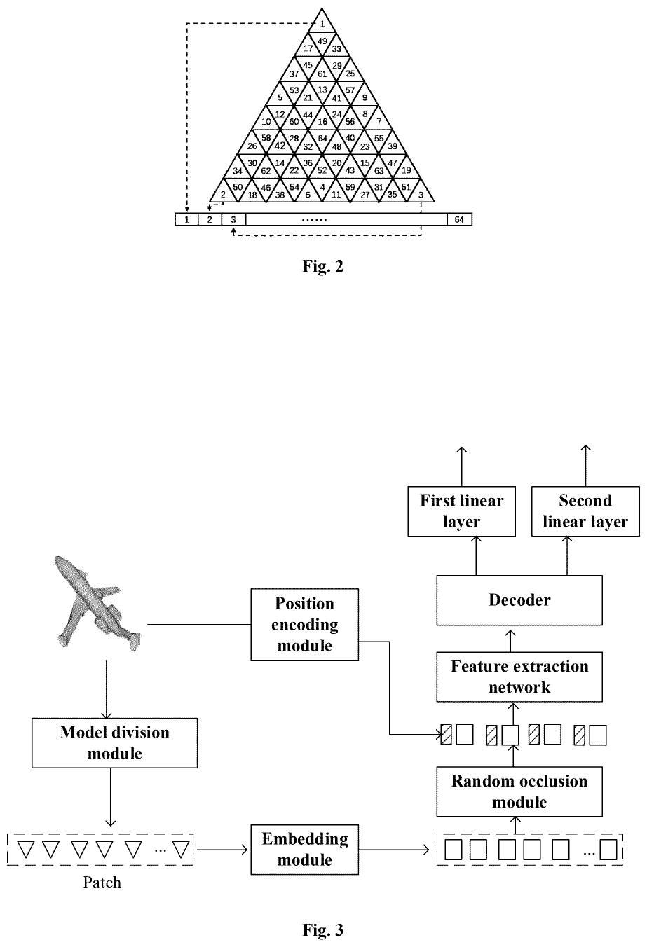

After simplifying the 3D mesh model into the base mesh model, the each of the base faces can be subdivided in a preset order, so that the obtained faces are also in the preset order. The information of the obtained faces is also concatenated according to the preset order to obtain the information of the patches. Furthermore, the geometric representation information of the each patch is obtained by concatenating the geometric representation information of each face in the each patch in the preset order. As shown in FIG. 2, each patch contains 64 faces, and the information of faces can be concatenated in the order of the numbers shown in the figure to obtain the information of the each patch.

In some embodiments, the positional representation information of each patch is determined by: determining coordinates of a center point of the each patch; determining a position encoding for the each patch based on the coordinates of the center point of the each patch. For example, the coordinates of the center point of the each patch are into a second MLP to output the position encoding of the each patch. The use of the coordinates of the center point of the each patch to determine the position encoding is more suitable for unordered geometric data, which can improve the accuracy of the position representation, and thus improve the training accuracy of the feature extraction network.

This disclosure introduces a training task for reconstructing occluded parts of a 3D mesh model. For a 3D mesh model, a certain proportion of the model is randomly occluded, and only visible portions are fed into the feature extraction network to learn an implicit expression. The randomly occluded portions are the second-type patches, and the visible portions are the first-type patches. Thus, the geometric representation information and positional representation information of each of first-type patches are input into the feature extraction network.

In some embodiments, the geometric representation information and the positional representation information of the each of the first-type patches are concatenated to obtain representation information of the each of the first-type patches; the representation information of the each of the first-type patches is input into the feature extraction network; and a correlation between every two first-type patches is determined based on a self-attention mechanism in the feature extraction network; and the each of the first-type patches is encoded based on the correlation between every two first-type patches to obtain a feature encoding of the each of the first-type patches.

In some embodiments, the feature extraction network comprises an input layer and one or more encoding layers. Each of the one or more encoding layers may comprise a self-attention layer, and each self-attention layer may comprise one or more attention heads. The each of the one or more encoding layers may further comprise: a MLP, a normalization layer, etc. The representation information of the each of the first-type patches is input into the input layer of the feature extraction network and then enters the one or more encoding layers via the input layer. For a first encoding layer, a representation matrix output from the input layer is used as an input, and for each subsequent encoding layer, a feature matrix (or encoding matrix) output from a previous encoding layer is used as an input. In each self-attention head, a value matrix, a query matrix, and a key matrix are determined based on a feature matrix input to the each self-attention head. By multiplying the query matrix by the key matrix and dividing by a square root of the number of columns in the key matrix, an attention score matrix is obtained. The attention score matrix is normalized to obtain a correlation matrix composed of correlations between different first-type patches. An attention encoding matrix corresponding to the each self-attention head is obtained by multiplying the correlation matrix by the value matrix. A feature matrix output from the each of the one or more encoding layers is determined based on the attention encoding matrix corresponding to the each self-attention head in the each of the one or more encoding layers. Each vector in the feature matrix output from the last encoding layer is used as the feature encoding of the each of the first-type patches.

For example, in each encoding layer, the attention encoding matrices corresponding to the self-attention heads are concatenated and then multiplied by a parameter matrix corresponding to the each encoding layer, and then input into a feedforward neural network or MLP to obtain a feature matrix output from the each encoding layer, which is further input into a next encoding layer.

For example, Transformer encoders can be used in the feature encoding network.

In step S108, predicted geometric representation of each face of the 3D mesh model is determined based on a feature encoding of the each of the first-type patches output from the feature extraction network, the mask embedding, and positional representation information of the each of the second-type patches.

In some embodiments, the feature encoding and the positional representation information of the each of the first-type patches are concatenated to obtain a code of the each of the first-type patches; the mask information and the positional representation information of each of the second-type patches are concatenated to obtain a code of the each of the second-type patches; the code of each of the first-type patches and the second-type patches are input into a decoder to obtain decoded information; and the decoded information is input into a first linear layer to obtain the predicted geometric representation information of the each face. The first linear layer can be a linear classifier.

In the training task of reconstructing occluded portions, the decoder predicts the occluded portions from implicit expression. By reconstructing the occluded portions, the feature extraction network can achieve geometric understanding of the 3D mesh model, thereby learning a better feature representation. By predict the geometric representation information of each face using the decoder and the first linear layer, that is, recovering the features of each face, the occluded faces are reconstructed.

In step S110, parameters of the feature extraction network are adjusted based on differences between the predicted geometric representation information and geometric representation information of the each face.

The geometric representation information of the each face is actual geometric representation information of the each face. In some embodiments, a first sub-loss function is determined based on the differences between the predicted geometric representation information and geometric representation information of the each face, and parameters of the feature extraction network are adjusted according to the first sub-loss function. For example, existing methods such as stochastic gradient descent can be used to adjust the parameters of the feature extraction network, which will not be repeated herein.

In some embodiments, a mean squared error (MSE) loss function is determined as the first sub-loss function based on the differences between the predicted geometric representation information and geometric representation information of the each face.

The 3D mesh model is composed of faces and vertices. In order to further improve the training accuracy of the feature extraction network, in addition to using the differences between the predicted geometric representation information and geometric representation information of the each face as an optimization objective, differences between the predicted coordinates and the actual coordinates of each vertex can also be used as an optimization objective.

In this case, steps S108 to S110 can be replaced by steps S109 to S111.

In step S109, predicted coordinate information of each vertex and predicted geometric representation information of each face of the 3D mesh model are determined based on the feature encoding of the each of the first-type patches output from the feature extraction network, the mask embedding, and the positional representation information of the each of the second-type patches.

In some embodiments, the feature encoding and the positional representation information of the each of the first-type patches are concatenated to obtain a code of the each of the first-type patches; the mask information and the positional representation information of the each of the second-type patches are concatenated to obtain a code of the each of the second-type patches; the code of each of the first-type patches and the second-type patches is input into a decoder to obtain decoded information; the decoded information is input into a second linear layer to obtain the predicted coordinate information of the each vertex. The second linear layer can be a linear classifier.

By predicting the predicted coordinate information of the each vertex using the decoder and the second linear layer, that is, recovering the features of the each vertex, the 3D mesh model is reconstructed in combination with the recovered features of the each face. For example, as shown in FIG. 2, each patch comprises 64 faces and 45 independent vertices. Coordinates are predicted for the 45 vertices in the each patch. When restoring a shape of the each patch, the predicted coordinate information of these 45 vertices must match their actual coordinate information.

In step S111, the parameters of the feature extraction network are adjusted based on the differences between the predicted geometric representation information and the geometric representation information of each face, as well as differences between the predicted coordinate information and actual coordinate information of the each vertex.

In some embodiments, a first sub-loss function is determined based on the differences between the predicted geometric representation information and the geometric representation information of the each face; a second sub-loss function is determined based on the differences between the predicted coordinate information and actual coordinate information of the each vertex; the first sub-loss function and the second sub-loss function are weighed and summed to obtain a loss function; the parameters of the feature extraction network are adjusted based on the loss function. For example, existing methods such as stochastic gradient descent can be used to adjust parameters of the feature extraction network, which will not be repeated herein.

In some embodiments, a chamfer distance between the predicted coordinate information and the actual coordinate information of the each vertex is determined; and the second sub-loss function is determined based on the chamfer distance between the predicted coordinate information and the actual coordinate information of the each vertex. For example, the predicted coordinate information of the each vertex are predicted relative coordinates of the each vertex, and the predicted relative coordinates of the each vertex are coordinates relative to the center point of a patch in which the each vertex is located. For example, the actual coordinates of the each vertex are actual relative coordinates of the each vertex, and the actual relative coordinates are coordinates of the vertex relative to the center point of a patch in which the each vertex is located.

For example, the second sub-loss function can be determined using the following formula.

$${L}_{C D} ( {P}_{r} , {G}_{r} ) = \frac{1}{\vert {P}_{r} \vert} {\sum }_{p ∈ {P}_{r}} {min}_{g ∈ {G}_{r}} ‖ p - g ‖ + \frac{1}{\vert {G}_{r} \vert} {\sum }_{g ∈ {G}_{r}} {min}_{p ∈ {P}_{r}} ‖ g - p ‖ \qquad ( 1 )$$

In the formula (1), n is the number of vertices in each patch, n is a positive integer,

$${P}_{r} = {\{ {p}_{{r}_{i}} \}}_{i = 1}^{n}$$

refers to the predicted relative coordinates of the n vertices, and

$${G}_{r} = {\{ {g}_{{r}_{i}} \}}_{i = 1}^{n}$$

refers to the actual relative coordinates of the n vertices.

Furthermore, the first sub-loss function can be represented as L_{MSE}, and can be expressed using the following formula.

$$L = {L}_{M S E} + λ \cdot {L}_{C D} \qquad ( 2 )$$

In the formula (e), L_{MSE} refers to the MSE loss function, i.e., the first sub-loss function; L_{CD} refers to the chamfer distance loss function, i.e., the second sub-loss function, and λ is a weight. For example, λ is set to 0.5.

In the above embodiment, the input data does not comprise the coordinates of the three vertices of each face, but the shape of the patch can be recovered through the training task of reconstructing occluded portions, demonstrating that the training task proposed in this disclosure can actually enable the feature extraction network to learn the geometric knowledge of the 3D mesh model.

During the training process, a plurality of 3D mesh models used for training may be divided into different batches. In each epoch, a batch of 3D mesh models is obtained to adjust the parameters of the feature extraction network using the method described in the above embodiments. This process is repeated in a plurality of epochs until the training is completed, which will not be described in detail.

Below, an overall network architecture involved in the training process according to some embodiments of the present disclosure will be described with reference to FIG. 3. As shown in FIG. 3, the overall network involved in the training process comprises a model segmentation module, an embedding module (such as a first multi-layer perceptron), a position encoding module (such as a second multi-layer perceptron), a random occlusion module, a feature extraction network (encoder), a decoder, a first linear layer, and a second linear layer. The model segmentation module is used to divide a 3D mesh model into a plurality of patches which do not overlap with each other, the embedding module is used to determine embedded coding of the patches, the position encoding module is used to determine position encodings of the patches, and the random occlusion module is used to select first-type patches and second-types patches for a random occlusion operation. The embedded coding and position encodings of the first-type patches are input into the feature extraction network. Feature encodings of the first-type patches outputted from the feature extraction network, the mask embeddings, and the position encodings of the patches are input the decoder. Decoded information output from the decoder are still encodings, which are further inputted into the first linear layer and the second linear layer to obtain predicted geometric representation information of each face, as well as predicted coordinate information of each vertex.

The feature extraction network (encoder) and the decoder can both be composed of multiple Transformer modules. The encoder and the decoder can be set asymmetrically. For example, the encoder can be set in 12 layers, while the decoder is set in a lightweight network of 6 layers. According to a preset ratio, a portion of the patches of the input mesh model (i.e., second-type patches) will be occluded, and only visible patches (i.e., first-type patches) will be fed to the encoder. Before entering the decoder, all occluded feature encodings are replaced by a shared learnable mask embedding, indicating that the patches at that location needs to be predicted. Therefore, the input of the decoder consists of the encodings of the visible patches and the mask embedding. Moreover, all feature encodings need to be added with position encodings, which can provide positional information for the occluded and visible patches. The decoder, first linear layer, and second linear layer are used for a reconstruction task during the training phase, and can be omitted in downstream tasks.

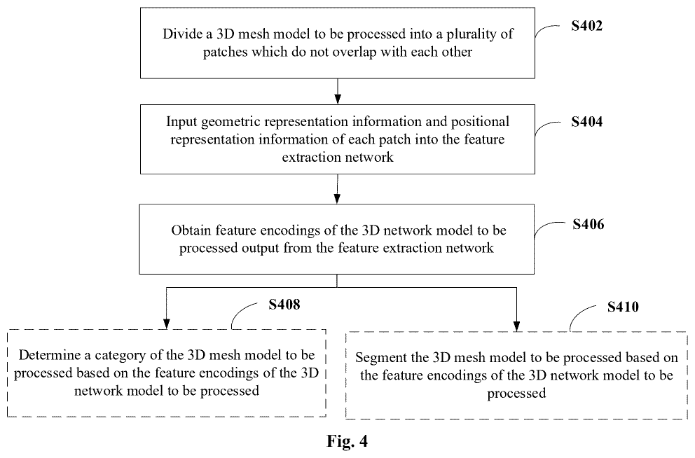

Below, a processing method for a 3D mesh model according to some embodiments of the present disclosure will be described with reference to FIG. 4.

FIG. 4 is a flowchart of a processing method for a 3D mesh model according to some embodiments of the present disclosure. As shown in FIG. 4, the method of this embodiment comprises steps S402 to S406.

In step S402, a 3D mesh model to be processed is divided into a plurality of patches which do not overlap with each other.

Each of the patches comprises a plurality of faces. In some embodiments, the 3D mesh model to be processed is simplified into a base mesh model having a third preset number of base faces to be processed; each of the base faces in the base mesh model to be processed is divided into a fourth preset number of faces, the fourth preset number of faces divided from the each of the base faces are taken as a patch. Reference can be made to the method of dividing the 3D mesh model in the training process of the previous embodiment, which will not be repeated here. The fourth preset number can be the same as the second preset number.

In step S404, geometric representation information and positional representation information of each patch are input into the feature extraction network.

The geometric representation information of the each patch comprises the geometric representation information of each face in the each patch. In some embodiments, the geometric representation information of each face comprises at least one of three interior angle degrees, an area, a normal vector or an inner product of three vertex vectors of the each face.

For example, the information (three interior angle degrees, an area, a normal vector, and an inner product of three vertex vectors) of all faces in the each patch are arranged and concatenated in a preset order as the information of the each patch. The information of the each patch is mapped to obtain embedded coding of the each patch as its geometric representation information. For the acquisition method of the geometric representation information of the each patch, reference can be made to the previous embodiments, which will not be repeated herein.

In some embodiments, the coordinates of a center point of the each patch are determined; the position encoding of the each patch is determined based on the coordinates of the center point of the each patch, for which reference can be made to the previous embodiments and will not be repeated here.

In step S406, feature encodings of the 3D network model to be processed output from the feature extraction network are obtained.

In the test or application phase, a 3D mesh model can be inputted in to the feature extraction network to obtain corresponding feature encodings without the need of occluding the 3D mesh model.

In some embodiments of the present disclosure, step S408 and/or step S410 may also be comprised after step S406.

In step S408, a category of the 3D mesh model to be processed is determined based on the feature encodings of the 3D network model to be processed.

For example, the feature encodings of the 3D network model to be processed are inputted into a classifier to obtain the category of the 3D mesh model to be processed. The feature extraction network trained in the above embodiments can be used as a pre-trained feature extraction network. The pre-trained feature extraction network and the classifier are concatenated to form a classification network. The parameters of the classification network can be adjusted using training samples, which will not be specifically described herein.

In step S410, the 3D mesh model to be processed is segmented based on the feature encodings of the 3D network model to be processed.

For example, the feature encodings of the 3D network model to be processed are inputted into a segmentation network to obtain portions segmented from the 3D mesh model to be processed. For example, a 3D mesh model of an aircraft can be segmented into parts such as nose, wings, fuselage, and tail. For the segmentation network, networks in the existing technology can be adopted, which will not be described herein. The feature extraction network trained in the above embodiments can be used as a pre-trained feature extraction network, which is concatenated with the segmentation network. The parameters of the concatenated feature extraction network and the segmentation network can be adjusted using training samples, which will not be specifically described herein.

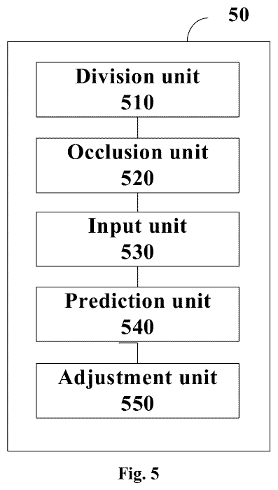

This disclosure also provides a training apparatus for a feature extraction network of a 3D mesh model, which will be described below with reference to FIG. 5.

FIG. 5 is a structural diagram of a training apparatus for a feature extraction network of a 3D mesh model according to some embodiments of the present disclosure. As shown in FIG. 5, the apparatus 50 of this embodiment comprises: a division unit 510, an occlusion unit 520, an input unit 530, a prediction unit 540, and an adjustment unit 550.

The division unit 510 is configured to divide a training 3D mesh model into a plurality of patches which do not overlap with each other, wherein each of the plurality of patches comprises a plurality of faces.

In some embodiments, the division unit 510 is configured to simplify a 3D mesh model to be processed into a base mesh model having a third preset number of base faces to be processed; and divide each of the base faces in the base mesh model into a second preset number of faces, and taking the second preset number of faces divided from the each of the base faces as a patch.

The occlusion unit 520 is configured to divide the plurality of patches into first-type patches and second-type patches, and using mask embedding as a feature encoding of each of the second-type patches.

In some embodiments, the occlusion unit 520 is configured to randomly select some patches from the plurality of patches according to a preset ratio as the second-type patches, and taking those not selected as the first-type patches.

The input unit 530 is configured to input geometric representation information and positional representation information of the each of the first-type patches into a feature extraction network.

In some embodiments, the geometric representation information of the each face comprises at least one of three interior angle degrees, an area, a normal vector, or an inner product of three vertex vectors of the each face.

In some embodiments, the input unit 530 is configured to determine coordinates of a center point of the each patch; and determine a position encoding for the each patch based on the coordinates of the center point of the each patch.

In some embodiments, the input unit 530 is configured to concatenate the geometric representation information and the positional representation information of the each of the first-type patches to obtain representation information of the each of the first-type patches; input the representation information of the each of the first-type patches into the feature extraction network; determine a correlation between every two first-type patches based on a self-attention mechanism in the feature extraction network; and encode the each of the first-type patches based on the correlation between every two first-type patches to obtain a feature encoding of the each of the first-type patches.

The prediction unit 540 is configured to determine predicted geometric representation information of each face of the 3D mesh model based on a feature encoding of the each of the first-type patches output from the feature extraction network, the mask embedding, and positional representation information of the each of the second-type patches.

The adjustment unit 550 is configured to adjust parameters of the feature extraction network based on differences between the predicted geometric representation information and geometric representation information of the each face.

In some embodiments, the prediction unit 540 is further configured to determine predicted coordinate information of each vertex based on the feature encoding of the each of the first-type patches output from the feature extraction network, the mask embedding, and the positional representation information of the each of the second-type patches; The adjustment unit 550 is further configured to adjust the parameters of the feature extraction network based on the differences between the predicted geometric representation information and the geometric representation information of each face, as well as differences between the predicted coordinate information and actual coordinate information of the each vertex.

In some embodiments, the adjustment unit 550 is configured to determine a first sub-loss function based on the differences between the predicted geometric representation information and the geometric representation information of the each face; determine a second sub-loss function based on the differences between the predicted coordinate information and actual coordinate information of the each vertex; weigh and sum the first sub-loss function and the second sub-loss function to obtain a loss function; and adjust the parameters of the feature extraction network based on the loss function.

In some embodiments, the adjustment unit 550 is configured to determine a mean square error loss function based on the differences between the predicted geometric representation information and the geometric representation information of the each face as the first sub-loss function.

In some embodiments, the adjustment unit 550 is configured to determine a chamfer distance between the predicted coordinate information and the actual coordinate information of the each vertex; and determine the second sub-loss function based on the chamfer distance between the predicted coordinate information and the actual coordinate information of the each vertex.

In some embodiments, the prediction unit 540 is configured to concatenate the feature encoding and the positional representation information of the each of the first-type patches to obtain a code of the each of the first-type patches; concatenate the mask information and the positional representation information of each of the second-type patches to obtain a code of the each of the second-type patches; input the code of each of the first-type patches and the second-type patches into a decoder to obtain decoded information; and input the decoded information into a first linear layer to obtain the predicted geometric representation information of the each face.

In some embodiments, the prediction unit 540 is configured to concatenate the feature encoding and the positional representation information of the each of the first-type patches to obtain a code of the each of the first-type patches; concatenate the mask information and the positional representation information of the each of the second-type patches to obtain a code of the each of the second-type patches; input the code of each of the first-type patches and the second-type patches into a decoder to obtain decoded information; and input the decoded information into a second linear layer to obtain the predicted coordinate information of the each vertex.

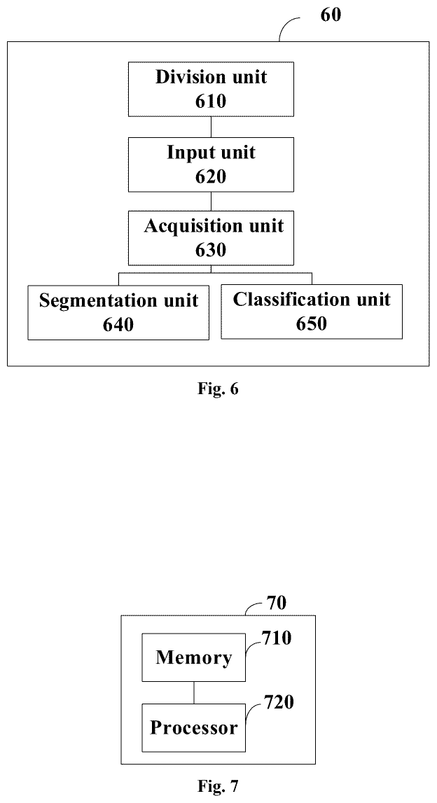

The present disclosure also provides a processing apparatus for a 3D mesh model, which will be described below with reference to FIG. 6.

FIG. 6 is a structure diagram of a processing apparatus for a 3D mesh model according to some embodiments of the present disclosure. As shown in FIG. 6, the apparatus 60 of this embodiment comprises: a division unit 610, an input unit 620, and an acquisition unit 630.

The division unit 610 is configured to divide a 3D mesh model to be processed into a plurality of patches which do not overlap with each other, wherein each of the plurality of patches comprises a plurality of faces.

In some embodiments, the division unit 610 is configured to simplify the 3D mesh model to be processed into a base mesh model to be processed having a third preset number of base faces; and divide each of the base faces in the base mesh model to be processed into a fourth preset number of faces, and take the fourth preset number of faces divided from the each of the base faces as a patch.

In some embodiments, the geometric representation information of the each face comprises at least one of three interior angle degrees, an area, a normal vector, or an inner product of three vertex vectors of the each face.

The input unit 620 is configured to input geometric representation information and positional representation information of each of the plurality of patches into a feature extraction network; and

In some embodiments, the input unit 620 is configured to determine coordinates of a center point of each patch; and determine a position encoding for each patch based on the coordinates of its center point.

The acquisition unit 630 is configured to obtain a feature encoding of the 3D network model to be processed output from the feature extraction network.

In some embodiments, the apparatus 60 further comprises at least one of: a segmentation unit 640 configured to segment the 3D mesh model to be processed based on the feature encodings of the 3D network model to be processed, and a classification unit 650 configured to determine a category of the 3D mesh model to be processed based on the feature encodings of the 3D network model to be processed.

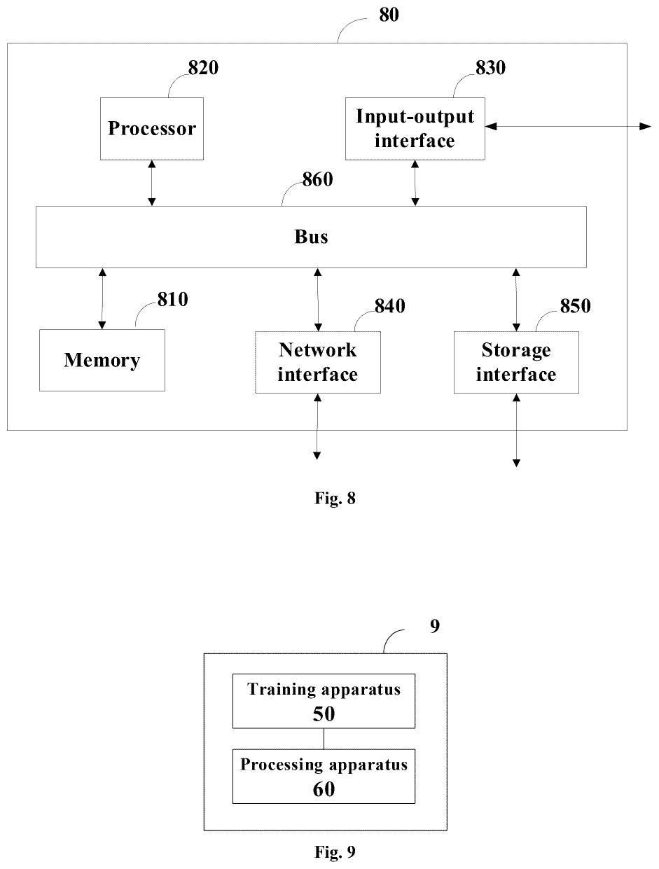

The electronic device of this embodiment of the present disclosure (the training apparatus for a feature extraction network of a 3D mesh model or the processing apparatus for a 3D mesh model) may be implemented by various computing devices or computer systems, which are described below with reference to FIGS. 7 and 8.

FIG. 7 is a structural diagram of an electronic device according to some embodiments of the present disclosure. As shown in FIG. 7, the electronic device 70 of this embodiment comprises: a memory 710 and a processor 720 coupled to the memory 710, the processor 720 configured to, based on instructions stored in the memory 710, carry out the training method for a feature extraction network of a 3D mesh model or the processing method for a 3D mesh model according to some embodiments of the present disclosure.

The memory 710 may comprise, for example, system memory, a fixed non-volatile storage medium, or the like. The system memory stores, for example, an operating system, applications, a boot loader, a database, and other programs.

FIG. 8 is a structural diagram of an electronic device according to some embodiments of the present disclosure. As shown in FIG. 8, the electronic device 80 of this embodiment comprises: a memory 810 and a processor 820 that are similar to the memory 710 and the processor 720, respectively. It may further comprise an input-output interface 830, a network interface 840, a storage interface 850, and the like. These interfaces 830, 840, 850, the memory 810 and the processor 820 may be connected through a bus 860, for example. The input-output interface 830 provides a connection interface for input-output devices such as a display, a mouse, a keyboard, and a touch screen. The network interface 840 provides a connection interface for various networked devices, for example, it can be connected to a database server or a cloud storage server. The storage interface 850 provides a connection interface for external storage devices such as an SD card and a USB flash disk.

This disclosure also provides a training system for a feature extraction network of a 3D mesh model, which will be described below with reference to FIG. 9.

FIG. 9 is a structural diagram of a training system for a feature extraction network of a 3D mesh model according to some embodiments of the present disclosure. As shown in FIG. 9, the system 9 of this embodiment comprises: the training apparatus 50 for a feature extraction network of a 3D mesh model and the processing apparatus 60 for a 3D mesh model according to any one of the foregoing embodiments.

The present disclosure further provides a computer program, comprising: instructions that, when executed by a processor, cause the processor to execute the training method for a feature extraction network of a 3D mesh model according to any one of the foregoing embodiments or the processing method for a 3D mesh model according to any one of the foregoing embodiments.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture comprising instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above is merely preferred embodiments of this disclosure, and is not limitation to this disclosure. Within spirit and principles of this disclosure, any modification, replacement, improvement and etc. shall be contained in the protection scope of this disclosure.

1. A training method for a feature extraction network of a 3D mesh model, comprising:
dividing a training 3D mesh model into a plurality of patches which do not overlap with each other, wherein each of the plurality of patches comprises a plurality of faces;
dividing the plurality of patches into first-type patches and second-type patches, and using mask embedding as a feature encoding of each of the second-type patches;
inputting geometric representation information and positional representation information of the each of the first-type patches into a feature extraction network;
determining predicted geometric representation information of each face of the 3D mesh model based on a feature encoding of the each of the first-type patches output from the feature extraction network, the mask embedding, and positional representation information of the each of the second-type patches; and
adjusting parameters of the feature extraction network based on differences between the predicted geometric representation information and geometric representation information of the each face.

2. The training method according to claim 1, wherein the dividing a training 3D mesh model into a plurality of patches which do not overlap with each other comprises:
simplifying the 3D mesh model into a base mesh model having a first preset number of base faces; and
dividing each of the base faces in the base mesh model into a second preset number of faces, and taking the second preset number of faces divided from the each of the base faces as a patch.

3. The training method according to claim 1, further comprising:
determining predicted coordinate information of each vertex based on the feature encoding of the each of the first-type patches output from the feature extraction network, the mask embedding, and the positional representation information of the each of the second-type patches,
wherein the adjusting parameters of the feature extraction network based on differences between the predicted geometric representation information and geometric representation information of each face comprises:
adjusting the parameters of the feature extraction network based on the differences between the predicted geometric representation information and the geometric representation information of each face, as well as differences between the predicted coordinate information and actual coordinate information of the each vertex.

4. The training method according to claim 3, wherein the adjusting the parameters of the feature extraction network based on the differences between the predicted geometric representation information and the geometric representation information of each face, as well as differences between the predicted coordinate information and actual coordinate information of the each vertex comprises:
determining a first sub-loss function based on the differences between the predicted geometric representation information and the geometric representation information of the each face;
determining a second sub-loss function based on the differences between the predicted coordinate information and actual coordinate information of the each vertex;
weighing and summing the first sub-loss function and the second sub-loss function to obtain a loss function; and
adjusting the parameters of the feature extraction network based on the loss function.

5. The training method according to claim 4, wherein:
the determining a first sub-loss function based on the differences between the predicted geometric representation information and the geometric representation information of the each face comprises:
determining a mean square error loss function based on the differences between the predicted geometric representation information and the geometric representation information of the each face as the first sub-loss function; and/or
the determining a second sub-loss function based on the differences between the predicted coordinate information and actual coordinate information of the each vertex comprises:
determining a chamfer distance between the predicted coordinate information and the actual coordinate information of the each vertex; and
determining the second sub-loss function based on the chamfer distance between the predicted coordinate information and the actual coordinate information of the each vertex.

6. (canceled)

7. The training method according to claim 1, wherein inputting geometric representation information and positional representation information of the each of the first-type patches into a feature extraction network comprises:
concatenating the geometric representation information and the positional representation information of the each of the first-type patches to obtain representation information of the each of the first-type patches;
inputting the representation information of the each of the first-type patches into the feature extraction network;
determining a correlation between every two first-type patches based on a self-attention mechanism in the feature extraction network; and
encoding the each of the first-type patches based on the correlation between different every two first-type patches to obtain a feature encoding of the each of the first-type patches.

8. The training method according to claim 1, wherein the determining predicted geometric representation information of each face of the 3D mesh model based on a feature encoding of the each of the first-type patches output from the feature extraction network, the mask embedding, and positional representation information of the each of the second-type patches comprises:
concatenating the feature encoding and the positional representation information of the each of the first-type patches to obtain a code of the each of the first-type patches;
concatenating the mask information and the positional representation information of each of the second-type patches to obtain a code of the each of the second-type patches;
inputting the code of each of the first-type patches and the second-type patches into a decoder to obtain decoded information; and
inputting the decoded information into a first linear layer to obtain the predicted geometric representation information of the each face.

9. The training method according to claim 3, wherein the determining predicted coordinate information of each vertex based on the feature encoding of the each of the first-type patches output from the feature extraction network, the mask embedding, and the positional representation information of the each of the second-type patches comprises:
concatenating the feature encoding and the positional representation information of the each of the first-type patches to obtain a code of the each of the first-type patches;
concatenating the mask information and the positional representation information of the each of the second-type patches to obtain a code of the each of the second-type patches;
inputting the code of each of the first-type patches and the second-type patches into a decoder to obtain decoded information; and
inputting the decoded information into a second linear layer to obtain the predicted coordinate information of the each vertex.

10. The training method according to claim 1, wherein the dividing a training 3D mesh model into a plurality of patches which do not overlap with each other comprises:
randomly selecting some patches from the plurality of patches according to a preset ratio as the second-type patches, and taking those not selected as the first-type patches.

11. The training method according to claim 1, wherein:
the geometric representation information of the each face comprises at least one of three interior angle degrees, an area, a normal vector, or an inner product of three vertex vectors of the each face; and/or
the positional representation information of each patch of the first-type patches and the second-type patches is determined by: determining coordinates of a center point of the each patch; and determining a position encoding for the each patch based on the coordinates of the center point of the each patch; and/or
the geometric representation information of the each of the first-type patches is obtained by concatenating the geometric representation information of faces in the each of the first-type patches in a preset order.

12.-13. (canceled)

14. A processing method for a 3D mesh model, comprising:
dividing a 3D mesh model to be processed into a plurality of patches which do not overlap with each other, wherein each of the plurality of patches comprises a plurality of faces;
inputting geometric representation information and positional representation information of each of the plurality of patches into a feature extraction network; and
obtaining a feature encoding of the 3D network model to be processed output from the feature extraction network.

15. The processing method according to claim 14, further comprising at least one of:
segmenting the 3D mesh model to be processed based on the feature encodings of the 3D network model to be processed; or
determining a category of the 3D mesh model to be processed based on the feature encodings of the 3D network model to be processed.

16. The processing method according to claim 14, wherein the dividing a 3D mesh model to be processed into a plurality of patches which do not overlap with each other comprises:
simplifying the 3D mesh model to be processed into a base mesh model to be processed having a third preset number of base faces; and
dividing each of the base faces in the base mesh model to be processed into a fourth preset number of faces, and taking the fourth preset number of faces divided from the each of the base faces as a patch.

17. The processing method according to claim 14, wherein the geometric representation information of the each face comprises at least one of three interior angle degrees, an area, a normal vector, or an inner product of three vertex vectors of the each face.

18. The processing method according to claim 14, wherein the positional representation of each patch is determined by:
determining coordinates of a center point of each patch; and
determining a position encoding for each patch based on the coordinates of its center point.

19.-20. (canceled)

21. An electronic device, comprising:
a processor; and
a memory coupled to the processor for storing instructions that, when executed by the processor, cause the processor to:
divide a training 3D mesh model into a plurality of patches which do not overlap with each other, wherein each of the plurality of patches comprises a plurality of faces; divide the plurality of patches into first-type patches and second-type patches, and using mask embedding as a feature encoding of each of the second-type patches; input geometric representation information and positional representation information of the each of the first-type patches into a feature extraction network; determine predicted geometric representation information of each face of the 3D mesh model based on a feature encoding of the each of the first-type patches output from the feature extraction network, the mask embedding, and positional representation information of the each of the second-type patches; and adjust parameters of the feature extraction network based on differences between the predicted geometric representation information and geometric representation information of the each face; and/or
divide a 3D mesh model to be processed into a plurality of patches which do not overlap with each other, wherein each of the plurality of patches comprises a plurality of faces: input geometric representation information and positional representation information of each of the plurality of patches into a feature extraction network; and obtain a feature encoding of the 3D network model to be processed output from the feature extraction network.

22. A non-transitory computer-readable storage medium having a computer program stored thereon, wherein the computer program when executed by a processor, causes the processor to execute the steps of the training method according to claim 1.

23.-24. (canceled)

25. An electronic device, comprising:
a processor; and
a memory coupled to the processor for storing instructions that, when executed by the processor, cause the processor to execute the steps of the processing method according to claim 14.

26. A non-transitory computer-readable storage medium having a computer program stored thereon, wherein the computer program when executed by a processor, causes the processor to execute the steps of the processing method according to claim 14.

27. A training system for a feature extraction network of a 3D mesh model, comprising the electronic device according to claim 21 as a first electronic device; and
a second electronic device comprising: a processor; and a memory coupled to the processor for storing instructions that, when executed by the processor, cause the processor to:
divide a 3D mesh model to be processed into a plurality of patches which do not overlap with each other, wherein each of the plurality of patches comprises a plurality of faces;
input geometric representation information and positional representation information of each of the plurality of patches into a feature extraction network; and
obtain a feature encoding of the 3D network model to be processed output from the feature extraction network.
